(19) United States
(12) Patent Application Publication
(10) Pub. No.: US 2006/0181594 A1
(43) Pub. Date: Aug. 17, 2006

(54) Electrostatic actuator and manufacturing method thereof, droplet discharging head and manufacturing method thereof, droplet discharging apparatus and device

(75) Inventors: Masahiro Fujii, Shiojiri (JP); Yasushi Matsuno, Matsumoto (JP); Akira Sano, Matsumoto (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/355,393

(22) Filed: Feb. 16, 2006

(30) Foreign Application Priority Data
Feb. 17, 2005 (JP) 2005-040112
Mar. 18, 2005 (JP) 2005-079323
Oct. 31, 2005 (JP) 2005-316072

(51) Int. Cl. B41J 2/41

(52) U.S. Cl. 347/112

(57) ABSTRACT

An electrostatic actuator includes: a diaphragm constituting one electrode; and an electrode substrate on which an opposed electrode opposite to the diaphragm has been formed with a gap, in which the opposed electrode is formed in a grooved portion, having a rectangular shape in plan view, formed on the electrode substrate and is formed in a plurality of steps such that the gap gradually increases stepwise toward a center part in a long edge direction of the grooved portion.

The entire disclosure of Japanese Patent Application No. 2005-040112, filed Feb. 17, 2005, Japanese Patent Application No. 2005-079323, filed on Mar. 18, 2005, Japanese PatentApplication No. 2005-316072, filed on Oct. 3,12005, is expressly incorporated by references herein.

### BACKGROUND OF THE INVENTION 1. Field of the Invention

The present invention relates to an electrostatic actuator and a manufacturing method thereof; a droplet discharging head having the electrostatic actuator applied thereto and a manufacturing method thereof; a droplet discharging apparatus comprising the droplet discharging head; and a device comprising the electrostatic actuator. 2. Description of the Related Art

An ink jet type recording apparatus has many advantages of realizing a high-speed printing, extremely reducing noises in printing, having a lot of flexibility of ink, being capable of using low-price regular paper, etc. In these days, among the ink-jet recording apparatuses, so-called ink-on-demand type ink-jet recording apparatuses, which discharge ink droplets only when recording is needed, have entered the mainstream. These ink-on-demand type ink jet recording apparatuses have advantages of eliminating the need for collecting ink droplets which have not been used for printing, etc.

These ink-on-demand type ink jet recording apparatuses include a so-called electrostatic driving type ink jet recording apparatus utilizing electrostatic force as driving means for discharging ink droplets, and also include a so-called piezoelectric driving type ink jet recording apparatus utilizing piezoelectric elements as driving means, and a so-called bubble jet (registered trademark) type ink jet recording apparatus utilizing heater elements, etc.

In the above-described electrostatic driving type ink jet recording apparatus, a diaphragm and an opposed electrode opposed thereto are electrically charged, thereby attracting and deflecting the diaphragm on the opposed electrode side. Such a mechanism for causing two objects to be electrically charged, thereby performing driving is generally referred to as an electrostatic actuator. In an apparatus having an electrostatic actuator applied thereto such as an ink jet recording apparatus, in general, a plurality of grooves are formed on a substrate (electrode substrate) made of a glass or the like, and an opposed electrode is formed inside of the groove, thereby providing a gap between the diaphragm and the opposed electrode.

In the recent ink jet recording apparatus, the achievement of high density has been accelerated, and the width of the diaphragm becomes small with this achievement of high density. Thus, there has been a problem that an ink discarding volume (planar area of diaphragm× gap width) is reduced, and an ink discharging quantity is reduced.

In order to solve this problem, there is a proposal for widening the gap, thereby ensuring the ink discarding volume. However, if the gap between the diaphragm and the opposed electrode is increased, there has been a problem that a drive voltage for driving the diaphragm must be increased.

In a conventional electrostatic actuator, an attempt has been made to lower a drive voltage, by making stepwise in a depth direction an elongate shaped groove in which an opposed electrode is to be formed, and then, providing two or more types of gap between the opposed electrode and the diaphragm (refer to Japanese Patent Application Laid-Open No. 2000-318155 (FIGS. 2, 4, and 5), for example).

In addition, an attempt has been made to form stepwise in a depth direction grooves in which an opposed electrode is to be formed, and then, widening a gap at a center part of the opposed electrode and the diaphragm, thereby alleviating radical warp at the center part of the diaphragm, preventing an increase in stress at the center part of the diaphragm, and then, improving durability of an ink jet head (refer to Japanese Patent Application Laid-Open No. 11-291482 (FIGS. 4 to 7), for example)

However, in the conventional electrostatic actuator and ink jet head as described above, an elongate shaped groove having an opposed electrode formed thereon is formed stepwise in a depth direction, and a gap is increased at a center part of the opposed electrode and the diaphragm. Thus, there has been a problem that a driving voltage is not lowered so much to make a long edge direction center part of the diaphragm having the greatest deformation due to slackness abut against the opposed electrode.

### SUMMARY

The present invention has been made to cope with the above-described problem. It is an aspect of the present invention to provide an electrostatic actuator and a manufacturing method thereof capable of driving at a low voltage even if a displacement quantity of one electrode constituting the electrostatic actuator is large. In addition, it is an aspect of the present invention to provide a droplet discharging head having the electrostatic actuator applied thereto and manufacturing method thereof; a droplet discharging apparatus comprising the droplet discharging head; and a device comprising the above-described electrostatic actuator.

An electrostatic actuator of the present invention comprises: a diaphragm constituting one electrode; and an electrode substrate on which an opposed electrode opposed to the diaphragm with a gap has been formed, and the opposed electrode is formed in a substantially rectangular grooved portion formed on the electrode substrate, and is formed in a plurality of steps (stepwise) in which the gap increases toward a center part in a long edge direction of the grooved portion. According to this electrostatic actuator, a greater momentum can be applied to a diaphragm than a case in which a grooved portion is made stepwise in a short edge (widthwise) direction. Therefore, even if a displacement quantity of the diaphragm is great, its driving voltage can be effectively lowered. In addition, a gap length is maximal at a center part of a grooved portion, and a gap is minimal at an end part of the grooved portion, and thus, the diaphragm is started to be deformed at both ends, and the driving voltage can be effectively lowered.

It is preferable that each step difference in steps of the opposed electrode is gradually made smaller in accordance with the long edge direction of the grooved portion from end part toward the center part thereof

As each step difference in the grooved portion formed in a stepwise is formed so as to be smaller in accordance with the direction from the end part of the grooved portion to a center part thereof, it is possible to abut the entire diaphragm against an opposed electrode at a driving voltage to abut the diaphragm against the opposed electrode at an end part of the diaphragm where the gap is the shortest. That is, it is possible to perform driving at a low driving voltage. Therefore, in the case where this actuator has been applied to a pressure change mechanism of a pressure chamber of a droplet discharging head, it is possible to ensure a sufficient droplet discharging quantity at a low driving voltage.

Further, at a boundary part of adjacent steps of the opposed electrode, it is preferable that the adjacent steps to each other are formed such that one of the steps extend in the other step, or a step difference transition part made of at least one recess portion is formed at an upper step end part of the adjacent steps, or alternatively, a step difference transition part made of at least one protrusive portion is formed at a lower step end part of the adjacent steps.

According to these electrostatic actuators, an electrostatic attraction force to attract a diaphragm at a stepped part is higher in order of abutment against an upper step part, abutment against a step difference boundary part, and abutment against a lower step part, and an electric field of a part to be abutted next due to abutment of the previous step part becomes serially higher. In this manner, it is possible to perform abutment between the diaphragm and the opposed electrode by utilizing an applied voltage corresponding to a narrow gap.

Further, it is preferable that a width orthogonal to the long edge direction of the opposed electrode is made gradually wider stepwise on face by face basis in order from the long edge direction end part of the grooved portion to the center part thereof. By doing this, the electrostatic attraction force acts in a wider range, and thus, continuous abutment of the adjacent stepped parts of the opposed electrode against the diaphragm is easily induced.

Further, the electrode substrate is preferably made of a boron silicate glass. By doing this, even if a silicon-based diaphragm is bonded with the electrode substrate, they are not remarkably different from each other in expansion rate, and thus, displacement due to a heat can be prevented. In addition, the opposed electrode is preferably made of ITO. Since ITO is transparent, there is an advantage to be able to check a discharge state at the time of anodic bonding between the electrode substrate and the silicon based diaphragm.

A droplet discharging head of the invention comprises any of the above-described the electrostatic actuators and the diaphragm constitutes a wall face of a pressure chamber to reserve and discharge droplets.

A droplet discharging apparatus of the invention has mounted thereon the above-described droplet discharging head.

A device of the invention comprises any of the above-described electrostatic actuators.

In these droplet discharging head, droplet discharging apparatus, and device, an operation of droplet discharging or the like can be performed at a low voltage, and equipment downsizing is possible.

An electrostatic actuator manufacturing method of the invention comprises: a groove forming step of applying a plurality of etchings to an electrode substrate, thereby forming a stepwise grooved portion whose planar shape is substantially a rectangle, the stepwise grooved portion deepening toward a center part in a long edge direction thereof; an electrode forming step of film-forming an electrode material inside the grooved portion, thereby forming an opposed electrode having a stepped shape which corresponds to a step difference of the grooved portion; and a bonding step of bonding the electrode substrate having passed the above steps and a diaphragm constituting one electrode or a substrate on which the diaphragm is to be formed later, so as to oppose the opposed electrode to the diaphragm or a planned face of the substrate where the diaphragm is formed later. According to this method, the electrostatic actuator having the above-described characteristics can be obtained.

It is preferable that step differences in steps of the grooved portion are made gradually made smaller in order from a long edge direction end part of the grooved portion to a center part thereof. In this manner, the step differences of the opposed electrode can also be concurrently reduced in order from the long edge direction end part to the center part.

Further, it is preferable that a width orthogonal to the long edge direction of the grooved portion is gradually made wider stepwise on face by face basis in order from the long edge direction end part of the grooved portion to the center part thereof. In this manner, the width of the opposed electrode can be concurrently increased in order from the long edge direction end part to the center part.

Further, thickness of a flat part of an opposed electrode formed inside of the grooved portion is preferably made larger than any step difference of the grooved portion. By film-forming the opposed electrode in this way, the opposed electrode can be prevented from being disconnected at the boundary part of the step difference.

In the groove forming step, a groove is preferably formed so that the adjacent steps at the boundary part of the steps of the grooved portion each are included into a counterpart side.

Further, in the groove forming step, a step difference transition part made of at least one recess portion is preferably formed at an upper step end part of the adjacent steps at the boundary part of steps of the grooved portion or a step difference transition part made of at least one protrusive portion is formed at a lower step end part of the adjacent steps.

By a droplet discharging head manufacturing method of the invention a pressure change mechanism of a pressure chamber for reserving and discharging droplets can be provided by applying any of the above-described the electrostatic actuator manufacturing method.

By this method, it is possible to provide a droplet discharging head having its high driving performance at a low driving voltage.

### BRIEF DESCRIPTION OF THE DRAWINGS

FIG. 1 is a sectional view showing an electrostatic actuator and a droplet discharging head according to a first embodiment of the present invention;

FIG. 2 is an enlarged sectional view showing a part of a grooved portion, an opposed electrode, and a diaphragm shown in FIG. 1;

FIG. 3 is an illustrative view of a driving voltage and a gap size for driving a diaphragm to abut against an opposed electrode;

FIG. 4 is an illustrative view of a driving voltage for driving a diaphragm to abut against an opposed electrode;

FIG. 5 is a sectional process chart showing one example of a method for manufacturing the droplet discharging head according to the first embodiment;

FIG. 6 is a process chart continued from FIG. 5;

FIG. 7 is a process chart continued from FIG. 6;

FIG. 8 is a sectional view showing an electrostatic actuator according to a second embodiment of the present invention;

FIG. 9 is a plan view illustrating a first constitution of a step difference part of an opposed electrode shown in FIG. 8;

FIG. 10 is a plan view illustrating a second constitution of a step difference part of the opposed electrode shown in FIG. 8;

FIG. 11 is a plan view illustrating a third constitution of a step difference part of the opposed electrode shown in FIG. 8; and

FIG. 12 is a perspective view illustrating a droplet discharging apparatus according to a third embodiment of the present invention.

### DESCRIPTION OF THE PREFERRED EMBODIMENTS

First embodiment

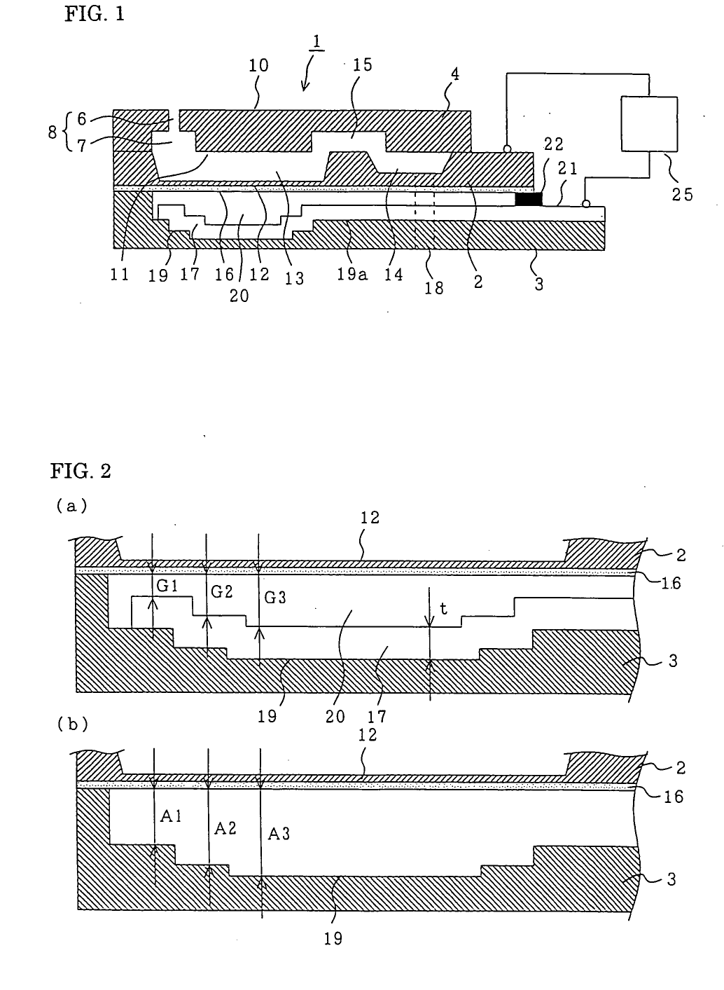

FIG. 1 is a longitudinal cross section showing a droplet discharging head according to a first embodiment of the present invention. FIG. 1 shows an example in which an electrostatic actuator according to the present invention has been applied to a droplet discharging head. This droplet discharging head is of a face eject type in an electrostatic driving system.

The droplet discharging head 1 according to the first embodiment is primary composed of a cavity substrate 2, an electrode substrate 3, and a nozzle substrate 4 by being bonded with each other.

The nozzle substrate 4 is made of a silicon or the like, and, for example, there is formed: a nozzle 8 having a cylindrically shaped first nozzle hole 6 and a cylindrically shaped second nozzle hole 7 communicating with the first nozzle hole 6 and whose diameter is greater than that of the first nozzle hole 6. The first nozzle hole 6 is formed so as to open on a droplet discharging surface 10 (opposite surface of a bonding face 11 with the cavity substrate 2), and the second nozzle hole 7 is formed to open on the bonding face 11 with the cavity substrate 2.

In addition, on the nozzle substrate 4, a recess portion serving as an orifice 15 for communicating a discharging chamber 13 and a reservoir 14 shown below is formed. These orifices 15 are formed with respect to a plurality of discharging chambers 13 on a one by one basis. The orifices 15 may be formed in the cavity substrate 2 at the side of the nozzle substrate 4.

The cavity substrate 2 is made of monocrystal silicon, for example, and recess portions serving as the discharging chamber 13 are formed in plurality. A bottom wall which is one of the wall faces constituting the discharging chamber 13 is provided as a diaphragm 12 having flexibility. A plurality of discharging chambers 13 are assumed to be formed and arranged in parallel from the front side to the back side shown in FIG. 1. In addition, on the cavity substrate 2, a recess portion serving as the reservoir 14 for supplying droplets such as ink to each discharging chamber 13 is formed. At the droplet discharging head 1 shown in FIG. 1, the reservoir 14 is assumed to be formed of a single recess portion.

Further, an insulation film 16 made of silicon oxide aluminum oxide or the like is formed on a face of the cavity substrate 2 on which the electrode substrate 3 is to be bonded. This insulation film 16 is intended to prevent insulation breakage or short-circuit at the time of driving of the droplet discharging head 1. In addition, a droplet proof protective film (not shown) made of silicon oxide or the like is formed on a face of the cavity substrate 2 on which the nozzle substrate 4 is to be bonded. This droplet proof protective film is intended to prevent the cavity substrate 2 from being etched due to the droplets inside the discharging chamber 13 or the reservoir 14.

The electrode substrate 3 made of a boron silicate glass, for example, is bonded at the side of the diaphragm 12 of the cavity substrate 2. On a bonding face of this electrode substrate 3, a plurality of grooved portions 19 are formed in a rectangular shape having short edges and long edges. This grooved portion 19 is formed stepwise such that it is the deepest at the center in the long edge direction and it is made shallower toward both ends. Here, the grooved portion 19 is referred to as a part facing the diaphragm 12, and is distinguished from a communication groove 19 a communicating with an electrode taking-out portion 21. In addition, an opposed electrode 17 opposed to the diaphragm 12 constituting another electrode is formed inside the grooved portion 19. This opposed electrode 17 is formed by sputtering ITO (Indium Tin Oxide), for example. A space between the grooved portion 19 and the opposed electrode 17 is provided as a gap (space) 20. A detailed description will be given later with respect to the grooved portion 19 and the opposed electrode 17.

Further, an ink supplying hole 18 communicating with the reservoir 14 is formed in the electrode substrate 3. This ink supplying hole 18 communicates with a hole provided in a bottom wall of the reservoir 14, and is provided to supply droplets such as ink from the outside to the reservoir 14. In addition, a space formed by the gap 20 and the communication groove 19 a is sealed by means of a sealing material 22 in order to prevent moisture or the like from entering the gap 20.

Now, an operation of the droplet discharging head 1 shown in FIG. 1 will be described here. A driving circuit 25 is connected to the cavity substrate 2 and individual opposed electrodes (referred to as individual electrodes) 17. A connection between the opposed electrodes 17 and the driving circuit 25 are made at a part of the electrode taking-out portion 21. When a pulse voltage is applied between the cavity substrate 2 and an electrode 17 by means of the driving circuit 25, the diaphragm 12 bends to the side of the opposed electrode 17, and the droplets such as ink reserved inside the reservoir 14 flow into a discharging chamber 13. In the first embodiment, when the diaphragm 12 bends, the opposed electrode 17 and the diaphragm 12 abut against each other (via the insulation film 16). Then, when the voltage applied between the cavity substrate 2 and the electrode 17 is removed, the diaphragm 12 is restored to its original position; an internal pressure of the discharging chamber 13 increases; and droplets such as ink are discharged from the nozzle 8. In this way, in the first embodiment, an electrostatic actuator is composed of the diaphragm 12 and the opposed electrodes 17. An electronic actuator can be so referred to, including the diaphragm 12, the opposed electrodes 17, and the driving circuit 25.

The first embodiment shows a droplet discharging head of electrostatic driving system as an example of applying the electrostatic actuator according to the present invention. The droplet discharging head and manufacturing method thereof shown in the first embodiment can also be applied to a MEMS (Micro Electro Mechanical Systems) device such as micro-pump.

FIG. 2 is a partially enlarged longitudinal cross section of the grooved portion 19, the opposed electrode 17, and the diaphragm 12 shown in FIG. 1. FIG. 2(a) is an enlarged longitudinal cross section including the opposed electrode 17, and FIG. 2(b) is an enlarged longitudinal cross section of a state in which the opposed electrode 17 is excluded. In addition, each of FIGS. 2(a) and 2(b) shows a cross section along a long edge direction of the grooved portion 19, wherein a short edge direction of the grooved portion 19 is in a direction from the front side to the back side of the paper.

As shown in FIG. 2(b), the stepwise grooved portion 19 is formed to be the deepest at the center part in the long edge direction (depth A3); to be shallower than the center part at halfway parts between both ends and the center part (depth A2); and to be the shallowest at parts which are the closest to both ends (depth A1). That is, a relationship of A3>A2>A1 is established. Although the grooved portion 19 shown in FIGS. 1 and 2 is formed in a three-stepped stepwise shape, this grooved portion may be formed in a four or more-stepped stepwise shape. In addition, it is preferable that step differences in grooved portion 19 shown in FIG. 2(b) are gradually made smaller from both ends of the grooved portion 19 to the center part thereof. However, there is not necessarily a need for forming such a shape, and a relationship of (A2−A1)≧(A3−A2) may be adopted. In the droplet discharging head according to the first embodiment, a relationship of A1>(A2−A1)>(A3−A2) is assumed to be met.

As shown in FIG. 2(a), in the droplet discharging head 1, the opposed electrode 17 is formed inside of the stepwise grooved portion 19. This opposed electrode 17 is formed by sputtering ITO, for example, and in general, the opposed electrode 17 is formed inside of the grooved portion 19 with the same film thickness. In this way, in the case where the opposed electrode 17 is formed with the same film thickness at a flat part of the grooved portion 19, a gap (size of gap 20) between the diaphragm 12 and the opposed electrode 17 is obtained as G3=A3−t at the center part in the long edge direction of the grooved portion 19; G2=A2−t at the halfway parts; and G1=A1−t at the part closest to the both ends, where the thickness of the opposed electrode 17 is defined as “t”.

From the above relationship, a relationship of G3>G2>G1 is established, and a relationship of G1>(G2−G1)>(G3−G2) is also established. That is, a gap between the diaphragm 12 and the opposed electrode 17 is made shorter in order from the center part in the long edge direction of the grooved portion 19 to both ends thereof, and differences in gap between steps are made smaller in order from both ends to the center part of the grooved portion 19.

In the first embodiment, the thickness “t” at a flat part in the grooved portion 19 of the opposed electrode 17 is formed to be larger than any step difference of the grooved portion 19 formed stepwise. This means that a relationship of t>(A2−A1)>(A3−A2) is established. In this manner, the step-out (disconnection) at the stepped part of the opposed electrode 17 can be prevented.

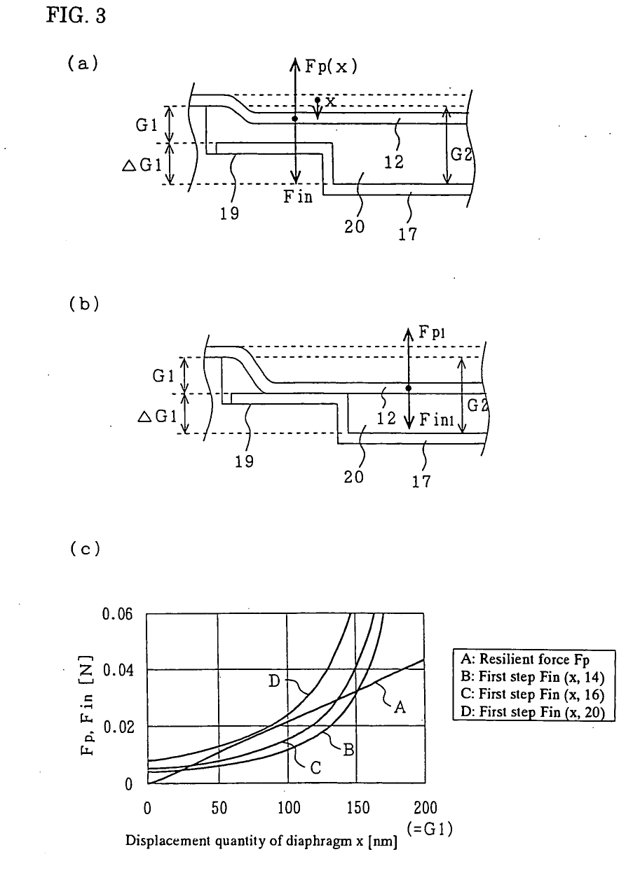

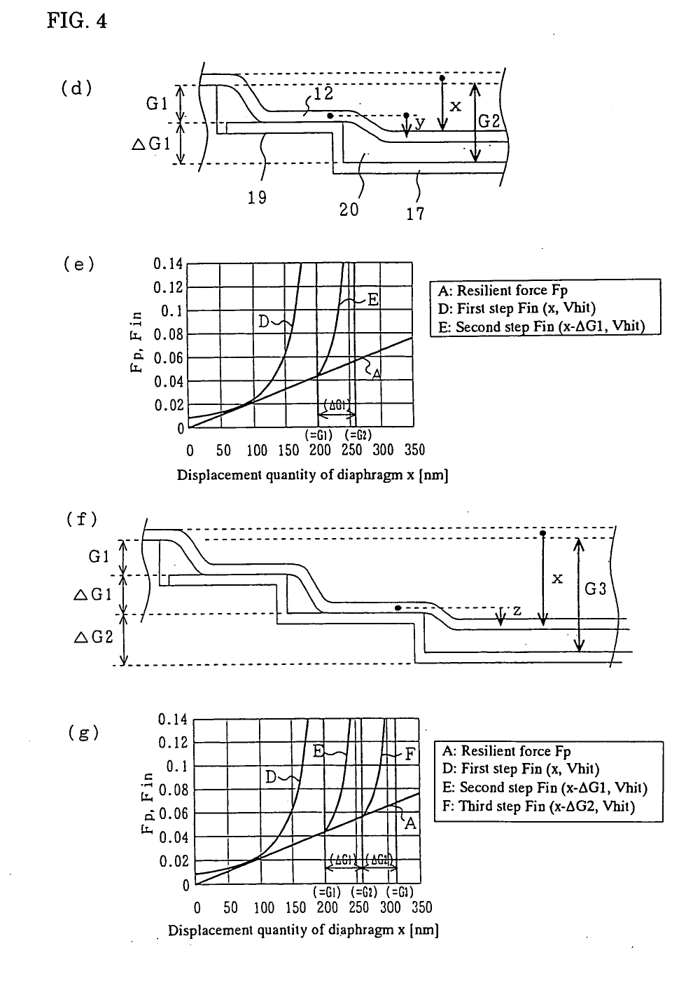

FIGS. 3 and 4 are views for illustrating a driving voltage and a gap for driving a diaphragm to abut against an opposed electrode. In FIGS. 3 and 4, a description will be given by way of exemplifying a model that the diaphragm 12 is gradually deformed from both ends of the grooved portion 19 where electrostatic force is the strongest. In general, the diaphragm 12 is practically started to be driven at substantially the same time at both ends and the center of the grooved portion 19. In addition, in FIGS. 3 and 4, the diaphragm 12 includes the insulation film 16 formed on the side of the gap 20 of the diaphragm 12, and is not shown here. Further, in FIGS. 3 and 4, the thickness of the opposed electrode 17 is shown to be smaller than actual for the sake of easy understanding.

FIG. 3(a) is a longitudinal cross section showing an end (left side) of the grooved portion 19. The droplet discharging head shown in FIG. 3(a) is identical to the droplet discharging head 1 shown in FIGS. 1 and 2, and the initial position of the diaphragm 12 is indicated by dotted line. In addition, ΔG1=(G2−G1) is established.

When G1 is a gap between the diaphragm 12 and the opposed electrode 17 at both ends of the grooved portion 19, “x” is a displacement quantity toward the opposed electrode 17 of the diaphragm 12, and V is an electric potential difference between the diaphragm 12 and the opposed electrode 17, an electrostatic force Fᵢₙ acting between the diaphragm 12 and the opposed electrode 17 at both ends of the grooved portion 19 is represented by the formula below.

$$\begin{matrix}[ Formula 1 ] & \\ {F}_{in} = {F}_{in} ( x , V ) = α {( \frac{V}{G 1 - x} )}^{2} ( α is a constant ) & ( 1 )\end{matrix}$$

In addition, when the diaphragm 12 bends, a resilient force Fₚ acting on the diaphragm 12 is represented by the formula below.

$$\begin{matrix}[ Formula 2 ] & \\ {F}_{p} = {F}_{p} ( x ) = \frac{x}{C} ( C is a constant ) & ( 2 )\end{matrix}$$

The constant C in formula (2) is defined from a material constant or dimensions and the like of the diaphragm 12.

Here, as shown in FIG. 3(b), in order to ensure that the diaphragm 12 abuts against an end portion of the grooved portion 19 having a gap G1, an electric potential difference Vₕᵢₜ should be applied between the diaphragm 12 and the opposed electrode 17 such that the electrostatic force Fᵢₙ always exceeds the resilient force Fₚ while the displacement quantity “x” of the diaphragm 12 is varying.

When this difference is represented by the formula,

[Formula 3]
Fᵢₙ (x,Vₕᵢₜ,)≧Fₚ(x) (3)

is always established.

FIG. 3(c) is a graph depicting a relationship between the electrostatic force Fᵢₙ acting between the diaphragm 12 and the opposed electrode 17 at both ends of the grooved portion 19 and the resilient force Fₚ acting on the diaphragm 12. FIG. 3(c) shows data using a general droplet discharging head, wherein G1=200 (nm) is established. In addition, volt (V) is used as a unit of an electric potential difference, and a nano-meter (nm) is used as a displacement quantity of the diaphragm 12.

As shown in FIG. 3(c), in the case where an electric potential difference between the diaphragm 12 and the opposed electrode 17 is 14V (curve B of FIG. 3(c)) and 16V (curve C of FIG. 3(c)), there is a part at which the electrostatic force Fᵢₙ does not exceeds the resilient force Fₚ (straight line A of FIG. 3(c)), and the diaphragm 12 does not abut against both ends of the opposed electrode 17 having the gap G1. However, in the case where an electric potential difference between the diaphragm 12 and the opposed electrode 17 is 20V (curve D of FIG. 3(c)), the electrostatic force Fᵢₙ always exceeds the resilient force Fₚ, and thus, the diaphragm 12 abuts against both ends of the opposed electrode 17 having the gap G1. Namely, Vₕᵢₜ=20 (V) is established. According to the configuration of the present invention, the diaphragm 12 is driven at this electric potential difference Vₕᵢₜ, thereby making it possible to abut the entirety of the diaphragm 12 against the opposed electrode 17. The reason is described below.

As shown in FIG. 3(b), in a state in which the diaphragm 12 has abutted against a part of the gap G1 of the opposed electrode 17, an electrostatic force Fᵢₙ₁ acting between the diaphragm 12 and the opposed electrode 17 at a part having a gap G2 and a resilient force Fₚ₁ acting on the diaphragm 12 (refer to FIG. 3(b)) is represented by the formula below.

$$\begin{matrix}[ Formula 4 ] & \\ {F}_{in} = {F}_{in} ( Δ G 1 , {V}_{hit} ) = α {( \frac{{V}_{hit}}{Δ G 1} )}^{2} & ( 4 ) \\ [ Formula 5 ] & \\ {F}_{p 1} = {F}_{p} ( G 1 ) = \frac{G 1}{C} & ( 5 )\end{matrix}$$

In the formulas, if ΔG1 is set so as to meet Fₚ₁<Fᵢₙ₁, there is no need for an electric potential difference between the diaphragm 12 and the opposed electrode 17 to be greater than Vₕᵢₜ, making it possible to bend the diaphragm 12 at a part having a gap G2, and bending deformation as shown in FIG. 4(d) is produced.

At this time, an electrostatic force Fᵢₙ acting between the diaphragm 12 and the opposed electrode 17 at a part at of the gap G2 and a resilient force Fₚ acting on the diaphragm 12 is represented by the formulas below. In formulas (6) and (7), the diaphragm 12 is further deformed from a state shown in FIG. 3(b), and a displacement quantity is assumed to be y (nm) when bending occurs at a part of the gap G2 (refer to FIG. 4(b)).

$$\begin{matrix}[ Formula 6 ] & \\ \begin{matrix}{F}_{in} = α {( \frac{{V}_{hit}}{Δ G 1 - y} )}^{2} \\ = α {( \frac{{V}_{hit}}{G 1 - ( G 1 - Δ G 1 + y )} )}^{2} \\ = α {( \frac{{V}_{hit}}{G 1 - ( x - Δ G 1 )} )}^{2} \\ = {F}_{in} ( x - Δ G 1 , {V}_{hit} )\end{matrix} & ( 6 ) \\ [ Formula 7 ] & \\ {F}_{p} = {F}_{p} ( G1 + y ) = {F}_{p} ( x ) & ( 7 )\end{matrix}$$

Formulas (6) and (7) are rearranged by utilizing a relationship of x=G1+y.

FIG. 4(e) is a graph depicting a relationship between an electrostatic force Fᵢₙ acting between the diaphragm 12 and the opposed electrode 17 at the part of the gap G2; and a resilient force Fₚ acting on the diaphragm 12. In FIG. 4(e), it is assumed that ΔG1=67 (nm) is established, and G2=G1+ΔG1=200+67=267 (nm) is established. In addition, in FIG. 4(e), it is assumed that straight line A and curve D are identical to those shown in FIG. 3(c), and curve E is relevant to the part of the gap G2 of the grooved portion 19.

As shown in FIG. 4(e), if ΔG1 is properly set, the electrostatic force Fᵢₙ always exceeds the resilient force Fₚ. Thus, while an electric potential difference between the diaphragm 12 and the opposed electrode 17 is kept to be Vₕᵢₜ, the diaphragm 12 can abut against the part of the gap G2 of the opposed electrode 17.

Similarly, let us consider a center part of the opposed electrode 17 having a gap G3.

In a state in which the diaphragm 12 abuts against the part of the gap G2 of the opposed electrode 17, an electrostatic force Fᵢₙ₂ acting between the diaphragm 12 and the opposed electrode 17 at the part of the gap G2 and a resilient force Fₚ₂ acting on the diaphragm 12 are represented by the formulas below. In the formulas, ΔG2=(G3−G2 ) is assumed to be established.

$$\begin{matrix}[ Formula 8 ] & \\ {F}_{in2} = {F}_{in} ( Δ G 2 , {V}_{hit} ) = α ( \frac{{V}_{hit}}{Δ G 2} ) & ( 8 ) \\ [ Formula 9 ] & \\ {F}_{p2} = {F}_{p} ( G 2 ) = \frac{G 2}{C} & ( 9 )\end{matrix}$$

In the formulas, if ΔG2 is set so as to meet Fₚ₂<Fᵢₙ₂, there is no need for an electric potential difference between the diaphragm 12 and the opposed electrode 17 to be greater than Vₕᵢₜ, making it possible to bend the diaphragm 12 at the part of the gap G3, and bending deformation as shown in FIG. 4(f) is produced.

At this time, an electrostatic force Fᵢₙ acting between the diaphragm 12 and the opposed electrode 17 at the part of the gap G3 and a resilient force Fₚ acting on the diaphragm 12 is represented by the formulas below. In formulas (10) and (11), a displacement quantity of the diaphragm 12 bent at the part of the gap G3 is assumed to be z (nm) (refer to FIG. 4(f)).

$$\begin{matrix}[ Formula 10 ] & \\ \begin{matrix}{F}_{in} = α {( \frac{{V}_{hit}}{Δ G 2 - z} )}^{2} \\ = α {( \frac{{V}_{hit}}{G 1 - ( G 1 - Δ G 2 + z )} )}^{2} \\ = α {( \frac{{V}_{hit}}{G 1 - ( x - Δ G 1 - Δ G 2 )} )}^{2} \\ = {F}_{in} ( x - Δ G 1 - Δ G 2 , {V}_{hit} )\end{matrix} & ( 10 ) \\ [ Formula 11 ] & \\ {F}_{p} = {F}_{p} ( G 2 + z ) = {F}_{p} ( x ) & ( 11 )\end{matrix}$$

Formulas (10) and (11) are rearranged by utilizing a relationship of x=G2+z=G1+ΔG1+z.

FIG. 4(g) is a graph depicting a relationship between an electrostatic force Fᵢₙ acting between the diaphragm 12 and the opposed electrode 17 at a part at which the gap is G3; and a resilient force Fₚ acting on the diaphragm 12. In FIG. 4(g), it is assumed that ΔG2=54 (nm) is established, and G3=G1+ΔG1+ΔG2=200+67+54=321 (nm) is established. In addition, in FIG. 4(g). it is assumed that straight line A and curves D and E are identical to those shown in FIG. 4(e), and curve F is relevant to the part of the gap G3.

As shown in FIG. 4(g), if ΔG2 is properly set, the electrostatic force Fᵢₙ always exceeds the resilient force Fₚ. Thus, while an electric potential difference between the diaphragm 12 and the opposed electrode 17 is kept to be Vₕᵢₜ, the diaphragm 12 can abut against the part of the gap G3 of the opposed electrode 17.

Here, let us consider a condition of ΔG1 and ΔG2 for the diaphragm 12 to abut against the opposed electrode 17 at parts of the gaps G2 and G3.

In order to obtain a solution which meets Fₚ(0)<Fᵢₙ (0, Vₕᵢₜ), Fₚ₁<Fᵢₙ₁ and Fₚ₂<Fᵢₙ₂, here, for the sake of convenience, Fₚ₁=Fᵢₙ₁, and Fₚ₂=Fᵢₙ₂ are assumed to be established. With respect to a resilient force, Fₚ(0)<Fₚ₁<Fₚ₂ is established, and thus, Fₚ(0, Vₕᵢₜ)<Fᵢₙ₁<Fᵢₙ₂ is established.

When the following formula is substituted in this formula, a relational formula relevant to G1, ΔG1, and ΔG2 is obtained.

$$\begin{matrix}[ Formula 12 ] & \\ {F}_{in} ( 0 , {V}_{hit} ) = α {( \frac{{V}_{hit}}{G 1} )}^{2} & ( 12 )\end{matrix}$$

That is, a relational formula of G1>ΔG1>ΔG2 is obtained. This means that, if step differences are set so as to meet G1>(G2−G1)>(G3−G2), as described above, the entirety of the diaphragm 12 can be abutted against the opposed electrode 17 at a driving voltage Vₕᵢₜ for the diaphragm 12 to abut against the opposed electrode 17 at both ends (at parts at which the gap is the shortest). In this manner, it is possible to lower the driving voltage and to ensure a discharging quantity of droplets in the droplet discharging head 1, for example. The above described discussion relevant to the driving voltage for abutting the diaphragm 12 against the opposed electrode 17 and a step difference in the grooved portion 19 is similar to a case in which the step difference in the grooved portion 19 is four or more steps.

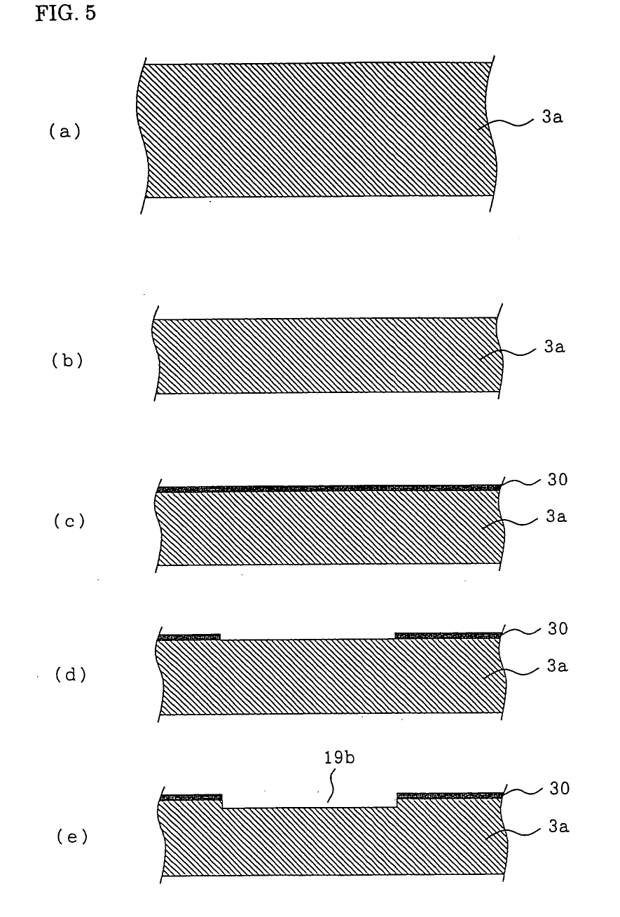

FIGS. 5, 6, and 7, are longitudinal cross sections showing the steps of manufacturing a droplet discharging head according to the first embodiment of the present invention. FIGS. 5 to 7, show the steps of manufacturing the droplet discharging head 1 shown in FIGS. 1 and 2, and show only the peripheries of the grooved portion 19. The method of manufacturing the droplet discharging head 1 is not limited to those shown in FIGS. 5 to 7.

First, for example, a substrate 3 a made of a boron silicate glass having thickness of 2 to 3 mm is prepared (FIG. 5(a)); mechanical grinding is performed for the thickness of the substrate 3a to be 1 mm, for example. Then, the entirety of the substrate 3a is etched by 10 to 20μm with a hydrofluoric acid water solution, to remove a layer deteriorated by the grinding (FIG. 5(b)). This removal of the deteriorated layer may be performed by dry etching using SF₆ or the like, for example, or may be performed by spin etching using hydrofluoric water solution. In the case where dry etching is performed, the deteriorated layer produced on one face of the substrate 3a can be efficiently removed, and there is no need for protecting an opposite face. In addition, in the case where spin etching is performed, an only small amount of etching liquid is required, and new etching liquid is always supplied, thus enabling stable etching. In the steps shown in FIG. 5(b), the substrate 3a may be thinned with only hydrofluoric acid water solution, for example, instead of mechanical grinding. In addition, after the steps shown in FIG. 5(b), surface treatment of the substrate 3a is performed with an acidic water solution, and the wettability of the substrate 3a is enhanced, whereby the etching in the subsequent steps can be accelerated.

Next, an etching mask 30 made of chromium (Cr) is formed fully on one face of the thinned substrate 3a by means of sputtering, for example (FIG. 5(c)).

Then, by means of photolithography, a resist (not shown) formed in a predetermined shape is patterned on a surface of an etching mask 30, thereby performing etching; and then, the etching mask 30 is formed as an opening formed in a shape which corresponds to a center part of the grooved portion 19 (part of gap A3) (FIG. 5(d)). This opening is formed in plurality as being shaped in a rectangular shape in general.

Then, for example, the substrate 3a is etched with a hydrofluoric water solution, thereby forming a first grooved portion 19b (FIG. 5(e)). At this time, an etching quantity (etching depth) is obtained to be (A3−A2) shown in FIG. 2(b).

Then, again by means of photolithography, a resist (not shown) formed in a predetermined shape is patterned on a surface of the etching mask 30, thereby forming etching; and the opening is broadened (FIG. 6(f)) on both sides of the long edge direction (paper face transverse direction of FIGS. 5 and 6) so that the etching mask 30 is formed in a shape which corresponds to a part of the gap A2 of the grooved portion 19 (refer to FIG. 2).

Then, for example, the substrate 3a is etched with a hydrofluoric acid water solution, for example, thereby forming a second grooved portion 19c (FIG. 6(g)). At this time, the etching quantity (etching depth) is obtained to be (A2−A1) shown in FIG. 2(b). The second grooved portion 19c is formed in a two-stepped shape, as shown in FIG. 6 (g).

Then, by means of photolithography again, a resist (not shown) formed in a predetermined shape is patterned on a surface of the etching mask 30, thereby performing etching; and the opening is broadened (FIG. 6(h)) on the both sides in the long edge direction so that the etching mask 30 is formed in a shape which corresponds to a part of the gap A1 of the grooved portion 19 (refer to FIG. 2). In the first embodiment, in the steps shown in FIG. 6(h), the etching mask 30 obtained as a part serving as the communication groove 19a is also removed.

Then, for example, the substrate 3a is etched with a hydrofluoric acid water solution, thereby forming the grooved portion 19 and the communication groove 19a, and then, the etching mask 30 is removed with a hydrofluoric acid water solution, for example (FIG. 6(i)). At this time, the etching quantity (etching depth) is obtained as A1 shown in FIG. 2(b). In this manner, a stepwise grooved portion 19 having a three-stepped flat face with depths A1, A2, and A3 is formed.

By repeating the above steps, the four or more stepped flat face grooved portion 19 may be formed.

Further, for example, by means of sputtering, an ITO (Indium Tin Oxide) film 31 is formed fully on a face of the substrate 3a on which the grooved portion 19 or the like has been formed (FIG. 6(j)). At this time, the thickness of the ITO film 31 is formed to be larger than any step difference of the stepwise grooved portion 19 (thickness “t” of the above opposed electrode). Then, a resist (not shown) is patterned by means of photolithography; the ITO film 31 is etched; the opposed electrode 17 is partitioned and formed; and the electrode substrate 3 is formed (FIG. 6(k)). In this manner, the opposed electrode 17 is formed such that gaps between the diaphragm 12 and the opposed electrode 17 are made of G1, G2, and G3 viewed from the end part side of the grooved portion 19.

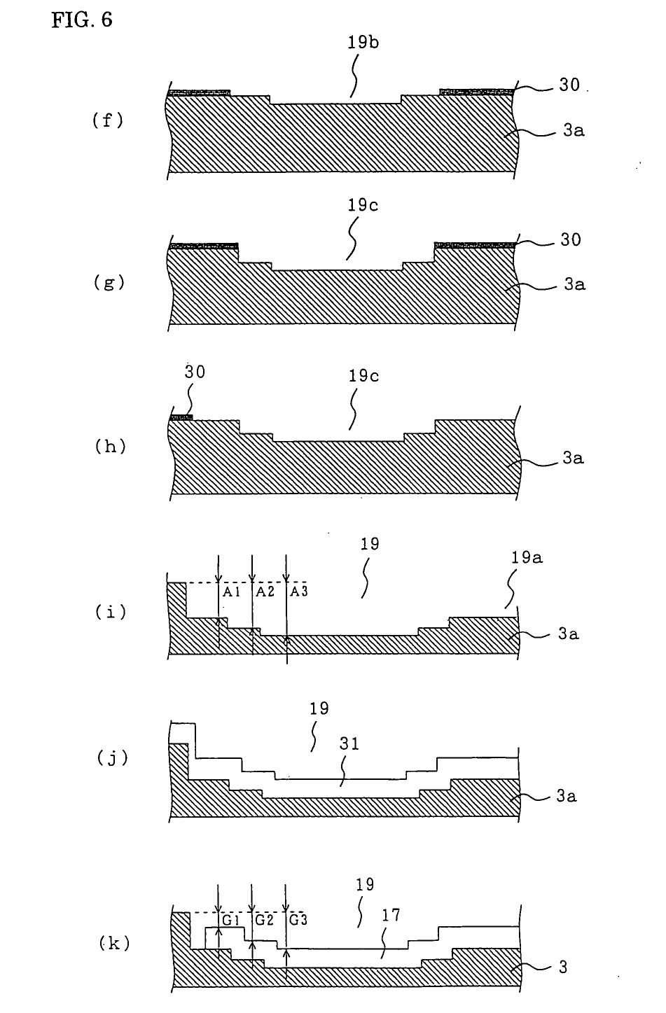

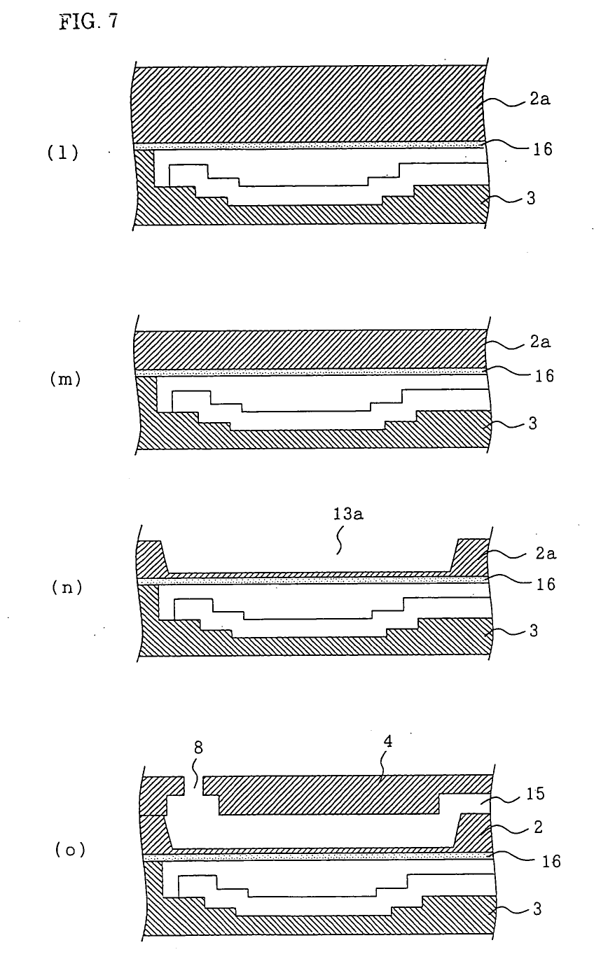

Then, for example, a silicon substrate 2a with thickness of 525 μm, having the insulation film 16 made of silicon oxide or the like formed on one face; and the electrode substrate 3 on which the opposed electrode 17 or the like have been formed in the steps shown up to FIG. 6(k) is heated at 360° C., for example; an anode and a cathode are connected to the silicon substrate 2a and the electrode substrate 3, respectively; a voltage of about 800 V is applied; and anodic bonding is performed (FIG. 7(1)). The silicon substrate 2 a and the electrode substrate 3 are bonded such that a face on which the insulation film 16 has been formed is bonded with a face on which the opposed electrode 17 or the like have been formed. The insulation film 16 can be formed by means of thermal oxidization or plasma VCD, for example.

After anodic-bonding the silicon substrate 2a and the electrode substrate 3 with each other, for example, the entirety of the silicon substrate 2a is thinned to have thickness of 140μm, for example, by mechanical grinding (FIG. 7(m)). After mechanical grinding has been performed, it is desirable that light etching be performed with potassium hydroxide water solution or the like in order to remove a layer deteriorated by prior processing. Instead of mechanical grinding, thinning of the silicon substrate 2a may be performed by means of wet etching using a potassium hydroxide water solution.

Then, by means of TEOS plasma CVD, for example, a silicon oxide film having thickness of 1.5 μm is formed fully on a top face of the silicon substrate 2a (an opposite face to a face on which the electrode substrate 3 is bonded).

Then, on this silicon oxide film, a resist is patterned for forming parts such as a recess portion serving as the discharging chamber 13; a recess portion serving as the reservoir 14; and a recess portion serving as the orifice, and the silicon oxide film of this part is removed by etching.

Thereafter, the silicon substrate 2a is subjected to anisotropic wet etching with a potassium hydroxide water solution or the like, thereby forming a recess portion 13a serving as the discharging chamber 13, the recess portion (not shown) serving as the reservoir 14, and the recess portion (not shown) serving as the orifice 15, and then, the silicon oxide film is removed (FIG. 7(n)). In the wet etching steps shown in FIG. 7(n), first, a potassium hydroxide water solution of 35% by weight can be used, and then, a potassium hydroxide water solution of 3% by weight can be used. In this manner, surface roughness of the diaphragm 12 can be restrained.

After the steps shown in FIG. 7(n), although a droplet proof protective film (not shown) made of silicon oxide or the like is formed to have thickness of 0.1 μm by means of CVD, for example, on a face of the silicon substrate 2a on which the recess portion 13a or the like serving as the discharging chamber 13 has been formed, the droplet proof protective film is not shown in FIG. 7(n).

Next, by means of ICP (Inductively Coupled Plasma) discharge or the like, the nozzle substrate 4 on which the recess portions serving as the nozzle 8 and the orifice 15 have been formed is bonded with the silicon substrate 2a (cavity substrate 2) by using adhesive or the like (FIG. 7(o)).

Lastly, for example, a bonded substrate consisting of the cavity substrate 2, the electrode substrate 3, and the nozzle substrate 4 bonded together is separate by dicing (cutting), and the droplet discharging head 1 is completed.

In the first embodiment, the opposed electrode 17 is formed stepwise such that the gap between the diaphragm 12 and the opposed electrode 17 is stepwise tapered from the center toward the end part in the long edge direction of the grooved portion 19. Thus, a greater momentum can be applied to the diaphragm 12 than that in a case in which the grooved portion 19 is formed stepwise in the short edge (widthwise) direction, and a driving voltage can be effectively lowered. In addition, the gap is maximal at the center part of the opposed electrode 17, and the gap is minimal at the end part of the opposed electrode 17, and thus, the diaphragm 12 is started to be deformed at both ends, and the driving voltage can be further effectively lowered.

In addition, the step difference of the grooved portion 19 formed stepwise is formed so as to be smaller in order from the end part of the grooved portion 19 to the center part thereof, and thus, the opposed electrode 17 is also formed in accordance with the above shape. In this manner, it is possible to abut the entirety of the diaphragm 12 against the opposed electrode 17 at a driving voltage at which the diaphragm 12 and the opposed electrode 17 abut against each other at the end parts with a minimal gap. In this manner, the driving voltage is lowered, and it is possible to ensure a practical discharging quantity of droplets in the droplet discharging head 1.

Unlike the above-described method, there is a method of bonding the cavity substrate 2, on which a flow passage of the diaphragm 12 and the discharging chamber 13 has been formed in advance, with the electrode substrate 3 on which the opposed electrode 17 has been formed.

In addition, in the case where an electrostatic actuator is not applied to the droplet discharging head, there is no need for forming a flow passage on a substrate on which the diaphragm 12 is formed, and there is no need for assembling the nozzle substrate 4.

Second Embodiment

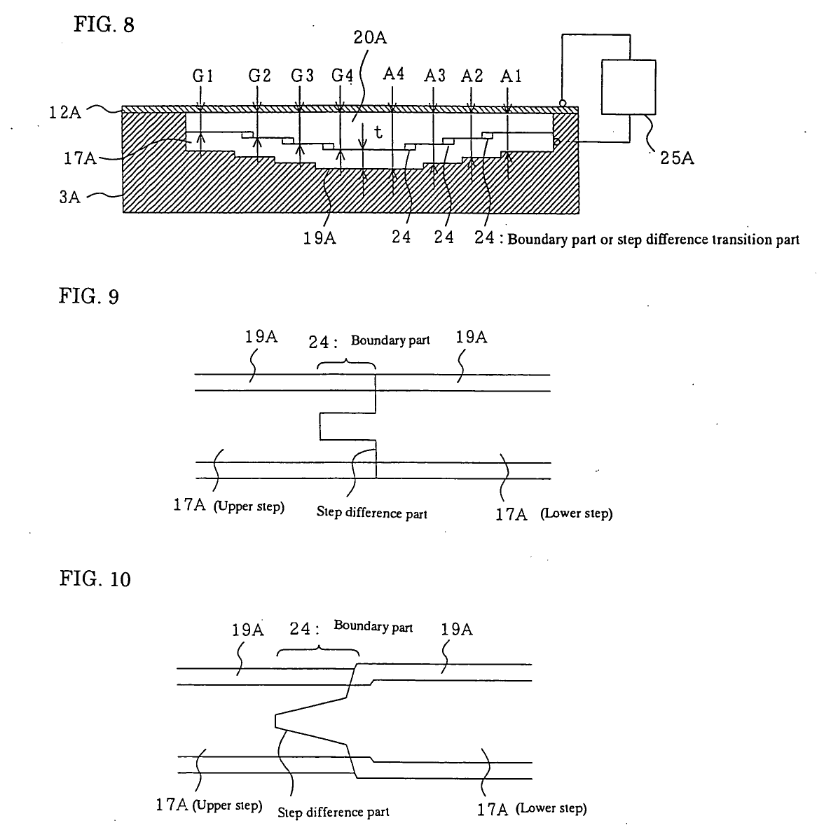

FIG. 8 is a schematic view of an electrostatic actuator according to a second embodiment of the present invention. This electrostatic actuator is equipped with: a diaphragm 12A made of a silicon or the like constituting one electrode; and an opposed electrode 17A formed on an electrode substrate 3A and opposed to the diaphragm 12A with a gap 20A. The diaphragm 12A may be referred to as a vibration film. Although an insulation film is formed on a face of the diaphragm 12A opposed to the opposed electrode 17A, this film is not shown here. Further, a driving circuit 25A is connected between the diaphragm 12A and the opposed electrode 17A for supplying a driving pulse between these electrodes.

The opposed electrode 17A is formed in a substantially rectangular shaped grooved portion 19A which is formed on the electrode substrate 3A. The opposed electrode 17A is formed in a plurality of steps so that the gap 20A widens (increases) toward the center part in the long edge direction of the grooved portion 19A. FIG. 8 shows a section along a long edge direction of the grooved portion 19A, and the short edge direction of the grooved portion 19A is defined as a direction from the front side to the back side of the paper.

In the case of the electrostatic actuator shown in FIG. 8, the opposed electrode 17A is constituted in four steps having step differences, and is formed in a transversely and substantially symmetrical manner. The gap 20A between each step of the opposed electrode 17A and the diaphragm 12A is G1, G2, G3, or G4 from the long edge direction end part toward the center part of the grooved portion 19A. The gap 20A is the widest at the center part, and is made narrower (smaller) in order from the center part to both ends in the long edge direction. That is, G4>G3>G2>G1 is established.

In the case of an electrostatic actuator for droplet discharging heads, the gap 20A can be, for example, G1=80 nm, G2=95 nm, G3=110 nm, and G4=120 nm.

Further, the step differences of steps of the opposed electrode 17A are preferably formed to be made smaller in order from the long edge direction end part to the center part of the grooved portion 19A. However, there is not necessarily a need for forming the step difference like that, and it is accepted as long as (G2−G1)≧(G3−G2) ≧(G4−G3) provided G1≧(G2−G1) is established. By doing this, the entirety of the diaphragm 12A is easily abutted against the opposed electrode 17A at a driving voltage at which the diaphragm 12A can abut against a part of the opposed electrode with the narrowest gap G1.

The thickness of the opposed electrode 17A is, in general, constant in each step in the long edge direction. Therefore, when the depths of the grooved portion 19 corresponding to gaps G1, G2, G3, and G4 are defined as A1, A2, A3, and A4, and the thickness of the opposed electrode 17A is defined as “t”, A1=G1+t, A2=G2+t, A3=G3 +t, and A4=G4+t are established. That is, A4>A3>A2>A1 is established.

The step differences of the grooved portion 19A are preferably formed to be associated with the step differences of the opposed electrode 17A, and the same step differences are preferably formed on the opposed electrode 17A by utilizing the step differences of the grooved portion 19A.

In addition, the thickness “t” of the opposed electrode 17A is preferably formed to be larger than any step difference of steps of the grooved portion 19A formed stepwise. In this manner, a relationship of t>(A2−A1)>(A3−A2) >(A4−A3) is established, and thus, a step out (disconnection) in a step difference part of the opposed electrode 17A can be prevented.

The opposed electrode 17A and the grooved portion 19A may be constituted in two steps, three steps, or five or more steps according to the size of the electrostatic actuator without being limited to the four-step constitution.

The opposed electrode 17A is obtained by: etching a glass substrate to form the grooved portion 19A; further film-forming ITO, for example, to be associated with the groove shape, in the grooved portion 19A; and patterning the film-formed ITO to form the opposed electrode. The electrode substrate 3A on which the opposed electrode 17A has been formed is bonded (for example, anodic-bonded) with the diaphragm 12A, whereby the electrostatic actuator can be obtained. Instead, the electrode substrate 3A on which the opposed electrode 17A has been formed may be anodic-bonded with a silicon substrate, and thus, the silicon substrate is processed so as to form the diaphragm 12A, whereby the electrostatic actuator can be obtained.

In the above-described electrostatic actuator, when a required sufficient voltage to make a part of the diaphragm 12A corresponding to G1 of the gap 20A abut against the opposed electrode 17A is applied between the diaphragm 12A and the opposed electrode 17A, the diaphragm 12A is retained in abutment against the first-step of the opposed electrode 17A with the narrowest gap 20A. At this time, at a part of gap G2 near a boundary part between G1 and G2, the gap 20A is temporarily obtained as (G2−G1), whereby a large electrostatic attraction force acts on the diaphragm 12A, and the diaphragm 12A at a part corresponding to G2 of the gap 20A also abuts against the opposed electrode 17A at the same voltage. Such a successive action is continuously induced up to a part of G4 which is the widest gap 20A. As a result, the entirety of the diaphragm 12A can abut against the opposed electrode 17A at a required sufficient voltage at which the diaphragm 12A can abut against the part of the opposed electrode 17 with the gap. Hereinafter, as described above, the way how the diaphragm 12A abuts against the opposed electrode 17A is referred to as continuous abutment.

As described above, the electrostatic actuator of the second embodiment is basically identical to an aspect of the first embodiment. In the second embodiment, in addition to the first embodiment, a contrivance is made at a boundary part (or step difference transition part) 24 of each step of the opposed electrode 17A for firmly retaining the diaphragm 12A by means of the opposed electrode 17A and then, reliably inducing the continuous abutment. Hereinafter, the constitution of the boundary part (or step difference transition part) 24 will be specifically described.

FIG. 9 is a plan view illustrating a first constitution of a step difference part of the opposed electrode 17A shown in FIG. 8. In FIG. 9, a step difference part of each step (each step face) of the opposed electrode 17A of the electrostatic actuator is constituted so that part of an end part of a lower step side (center part in this embodiment) is protruded in a rectangular shape, and is assembled into an upper step at a boundary part between the adjacent upper step (a shallow step face) and lower stapes (a deep step face), as illustrated. In this manner, the electrostatic attraction force for attraction the diaphragm 12A at this step difference part is produced in order of abutment at the upper step part, abutment at the boundary part, and abutment at the lower step part. Thus, an electric field at a part to abut following abutment of the front stage part becomes serially high. In this manner, abutment between the diaphragm 12A and the opposed electrode 17A is executed by a predetermined voltage in order from the long edge direction end part toward the center part of the opposed electrode 17A.

Contrary to the case of FIG. 9, it is possible that part of the end part at the upper step of the opposed electrode 17A is constituted so as to be assembled into the lower step.

FIG. 10 is a plan view illustrating a second constitution of a step difference part of the opposed electrode 17A shown in FIG. 8. A constitution shown in FIG. 10 is a modified example of the constitution shown in FIG. 9, and a boundary part including a step difference part of the opposed electrode 17A is constituted so that the center part of the end part of the lower step is protruded in a tapered shape and is assembled into the upper step. With this constitution, the attraction force at the boundary part having the step difference of the opposed electrode 17A is more significantly averaged, and continuous abutment of the diaphragm 12A against the opposed electrode 17A is performed more reliably. In this case as well, it is possible to constitute the center part of the end part of the upper step of the opposed electrode 17A so as to be assembled into the lower step.

In FIG. 10, the opposed electrode width and grooved portion width orthogonal to the long edge direction of the grooved portion 19A are constituted so that these lower stages are wider than the upper stages. In this manner, the continuous abutment is easily induced because the electrostatic attraction force relevant to the diaphragm 12A acts in a wider area as the gap 20A is wider. In addition, it is possible to easily avoid a malfunction due to a change in groove width caused by a pattern displacement when the grooved portion 19A is formed.

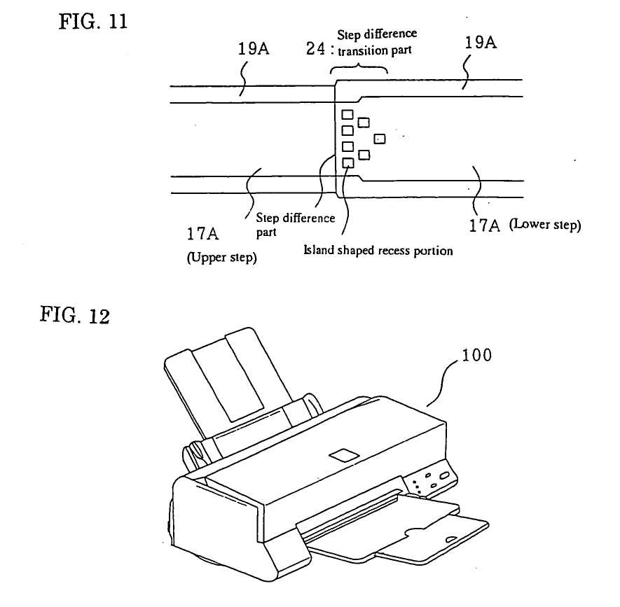

FIG. 11 is a plan view illustrating a third constitution of a step difference part of the opposed electrode 17A shown in FIG. 8. In FIG. 11, a boundary part including the step difference part of the opposed electrode 17A is constituted as the step difference transition part 24 for reliably inducing the continuous abutment described previously. That is, an island shaped protrusive portion is formed on an end part of a lower step in the adjacent upper and lower steps. Although the height of that protrusive portion is not limited, the height is preferably made equal to that of the adjacent upper step from the viewpoint of manufacturing the opposed electrode. In addition, although there is a case in which only one protrusive portion may suffice depending on its shape, a plurality of protrusive portions are preferably provided. In particular, it is preferable to dispose the protrusive portions densely at a part close to the upper step and to dispose sparsely at a part distant from the upper step.

In this way, the step difference transition part 24 is provided at the boundary part including the step difference part, whereby the electrostatic attraction force at the transition part is obtained as a force obtained by averaging the attraction force at the upper step part in the adjacent steps and the attraction force at the lower step part, and continuous abutment for a deeper gap is reliably induced. Therefore, the driving voltage can be made lowered.

An island shaped recess portion is constituted to be formed at the end part of the adjacent upper step instead of providing a protrusive portion at the lower step end part in the adjacent upper and lower steps of the opposed electrode 17A, whereby similar advantageous effect can be attained.

The electrostatic actuator according to the second embodiment can be manufactured in conformity with the method according to the first embodiment. In this case, it is preferable that the boundary part of each step difference of the opposed electrode 17 shown in FIGS. 9 to 11 or each shape of the step difference transition part 24 be formed based on the shape of the grooved portion 19 while the grooved portion 19 of the electrode substrate 3 is formed in advance to be associated with these shapes. However, it can be formed by repeating sputtering or the like for forming the opposed electrode 17 a plurality of times utilizing a mask.

In addition, a droplet discharging head similar to the droplet discharging head 1 described in the first embodiment can be obtained by utilizing the electrostatic actuator according to the second embodiment.

Third Embodiment

FIG. 12 is a perspective view showing one example of a droplet discharging apparatus according to a third embodiment of the present invention equipped with a droplet discharging head according to the present invention, for example, the droplet discharging head 1. A droplet discharging apparatus 100 shown in FIG. 12 is an ink jet printer in which a discharging liquid is ink. As has been already described, the droplet discharging head 1 is low in driving voltage and is sufficient in droplet discharging quantity, and thus, the droplet discharging apparatus 100 utilizing this capability is low in power consumption and is excellent in discharging performance as well.

The droplet discharging head 1 and the droplet discharging apparatus 100 can be applied to discharging of a variety of droplets such as ink, a solution including a filter material for color filters, a solution including a light emission material of an organic EL display device, or biological liquid.

In addition, the electrostatic actuator according to the present invention can be applied to a variety of other devices without being limited to application to the above-described droplet discharging head. If these devices are exemplified, the electrostatic actuator according to the present invention can be applied to a pump part of a micro-pump; a switch drive part of an optical switch; a mirror drive part of a mirror device for controlling an optical direction while a plurality of ultra-small sized mirrors are disposed in number, and these mirrors are inclined; and a drive part of a laser operation mirror of a laser printer. The electrostatic actuator as shown in the first embodiment is mounted on these device, making it possible to provide a device having excellent actuation property at a small driving voltage.

1. An electrostatic actuator comprising:
a diaphragm constituting one electrode; and
an electrode substrate on which an opposed electrode opposed to the diaphragm with a gap is formed,
wherein the opposed electrode is formed in a grooved portion having a substantially rectangular shape in plan view, formed on the electrode substrate, and is formed in a plurality of steps in which the gap increases toward a center part in a long edge direction of the grooved portion.

2. The electrostatic actuator according to claim 1, wherein each step difference in steps of the opposed electrode is gradually made smaller in accordance with the long edge direction from end part of the grooved portion toward the center part thereof.

3. The electrostatic actuator according to claim 1, wherein, at a boundary part of adjacent steps of the opposed electrode, the adjacent steps to each other are formed such that one of the steps extends in the other step.

4. The electrostatic actuator according to claim 1, wherein, at the boundary part of the adjacent steps of the opposed electrode, a step difference transition part made of at least one recess portion is formed at an upper step end part of the adjacent steps, or alternatively, a step difference transition part made of at least one protrusive portion is formed at a lower step end part of the adjacent steps.

5. The electrostatic actuator according to claim 1, wherein a width orthogonal to the long edge direction of the opposed electrode is made gradually wider stepwise on face by face basis in order from the long edge direction end part of the grooved portion to the center part thereof.

6. The electrostatic actuator according to claim 1, wherein the electrode substrate is made of a boron silicate glass.

7. The electrostatic actuator according to claim 1, wherein the opposed electrode is made of ITO.

8. A droplet discharging head comprising the electrostatic actuator according to claim 1, wherein the diaphragm constitutes a wall face of a pressure chamber to reserve and discharge droplets.

9. A droplet discharging apparatus, comprising the droplet discharging head according to claim 8.

10. A device comprising the electrostatic actuator according to claim 1.

11. An electrostatic actuator manufacturing method comprising:
a groove forming step of applying a plurality of etchings to an electrode substrate, thereby forming a stepwise grooved portion whose planar shape is substantially a rectangle, the stepwise grooved portion deepening toward a center part in a long edge direction thereof;
an electrode forming step of film-forming an electrode material inside the grooved portion, thereby forming an opposed electrode having a stepped shape which corresponds to a step difference of the grooved portion; and
a bonding step of bonding the electrode substrate having passed the above steps and a diaphragm constituting one electrode or a substrate on which the diaphragm is to be formed later so as to oppose the opposed electrode to the diaphragm or a planned face of the substrate where the diaphragm is formed later.

12. The electrostatic actuator manufacturing method according to claim 11, wherein step differences in steps of the grooved portion are gradually made smaller in order from a long edge direction end part of the grooved portion to a center part thereof.

13. The electrostatic actuator manufacturing method according to claim 11, wherein a width orthogonal to a long edge direction of the grooved portion is gradually made wider stepwise on face by face basis in order from the long edge direction end part of the grooved portion to the center part thereof.

14. The electrostatic actuator manufacturing method according to claim 11, wherein thickness of a flat part of an opposed electrode formed inside of the grooved portion is made larger than any step difference of the grooved portion.

15. The electrostatic actuator manufacturing method according to claim 11, wherein, in the groove forming step, a groove is formed so that at the boundary part of the adjacent steps of the grooved portion, one of the adjacent steps extends in the other step.

16. The electrostatic actuator manufacturing method according to claim 11, wherein, in the groove forming step, a step difference transition part made of at least one recess portion is formed at an upper step end part of the adjacent steps at the boundary part of steps of the grooved portion or a step difference transition part made of at least one protrusive portion is formed at a lower step end part of the adjacent steps.

17. A droplet discharging head manufacturing method constituting a pressure change mechanism of a pressure chamber for reserving and discharging droplets by applying the electrostatic actuator manufacturing method according to claim 12.
